(19) United States
(12) Patent Application Publication
(10) Pub. No.: US 2024/0104096 A1
(43) Pub. Date: Mar. 28, 2024

(54) HIGH LATENCY QUERY OPTIMIZATION SYSTEM

(71) Applicant: Microsoft Technology Licensing, LLC, Redmond, WA (US)

(72) Inventor: Nir NETES, Asker (NO)

(21) Appl. No.: 18/067,170

(22) Filed: Dec. 16, 2022

Related U.S. Application Data
(60) Provisional application No. 63/409,258, filed on Sep. 23, 2022.

(51) Int. Cl. G06F 16/2453; G06F 9/54; G06F 16/27

(52) U.S. Cl. CPC G06F 16/24542; G06F 9/54; G06F 16/278

(57) ABSTRACT

The described technology provides high latency query optimization method including receiving a data request from a client, the data request directed to data stored in a plurality of data shards, determining a set of operating parameters of the data shards for retrieving data from the plurality of shards, determining a chunking factor based on the set of operating parameters, dividing the data request into a plurality of API requests based on the chunking factor, each of the API requests directed to a portion of the plurality of data shards, and communicating the plurality of API requests in parallel to a source API configured to perform data queries on the plurality of data shards.

### CROSS-REFERENCE TO RELATED APPLICATIONS

The present application claims benefit of priority to U.S. Provisional Patent Application No. 63/409,258, entitled “High Latency Query Optimization System” and filed on Sep. 23, 2022, which is specifically incorporated by reference for all that it discloses and teaches in its entirety.

### BACKGROUND

Systems and scenarios that require fetching real-time data from multiple sources, for example for purposes of displaying information to a user, are often constrained by how much data they can collect at query-time from a slow data source. Here, data latency is the time it takes for data packets to be stored or retrieved. In computer networking and internet communications, data latency is the time it takes data to travel from a source to a destination, with the lower the network latency, the higher the speed and performance of a network.

### SUMMARY

The described technology provides high latency query optimization method including receiving a data request from a client, the data request directed to data stored in a plurality of data shards, determining a set of operating parameters of the data shards for retrieving data from the plurality of shards, determining a chunking factor based on the set of operating parameters, dividing the data request into a plurality of API requests based on the chunking factor, each of the API requests directed to a portion of the plurality of data shards, and communicating the plurality of API requests in parallel to a source API configured to perform data queries on the plurality of data shards.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example implementation of a high latency query optimization system disclosed herein.

FIG. 2 illustrates example operations of the high latency query optimization system disclosed herein.

FIG. 3 illustrates alternative example operations of the high latency query optimization system disclosed herein.

FIG. 4 illustrates example graphs of relationships between number of samples to various parameters of the query that may be used by a Kalman filter of the high latency query optimization system disclosed herein.

FIG. 5 illustrates an example system that may be useful in implementing the high latency query optimization system disclosed herein.

### DETAILED DESCRIPTIONS

Systems and scenarios that require fetching real-time data from multiple sources, for example for purposes of displaying information to a user, are often constrained by how much data they can collect at query-time from a slow data source. For example, middle-tier backend services working with multiple clients are often required to collect data from many different data sources. Often, one or more of these multiple data sources may slower to respond than other of such multiple data source at query time. As a result, the middle tier service may not be able to meet strict latency requirements.

Furthermore, for data-driven applications or websites it is important that data scaling is done in a way that ensures the security and integrity of the data. Databases that are target of the queries from such middle tier service may be organized in a number of data shards. Here the data shards may be horizontal partitions of data in a database or a search engine. Data sharding may include breaking up data into two more smaller chunks. Such data shard may be called logical shards. Such logical shards may be distributed across multiple database nodes and maybe referred to as physical shards. In some implementations, such physical shards may hold data from various logical shards.

To spread the data load, each data shard may be held on a separate data server with each shard storing rows of database. The queries generated by the middle tier service may either pertain to collect data from a single shard or may require collecting data from a large number of data shards of a database. In such an implementation, the latency of the response from one or more of the database shards may be more than latency of the other data shards and as a result, the latency of serving a data request from a client may be bottlenecked by the data shard with the highest latency (slowest response).

A high latency query optimization system disclosed herein allows retrieving data organized in data shard faster, more efficiently, and in a more flexible manner. Specifically, the technology disclosed herein includes a high latency query optimization system where a middle tier backend service receives a data request from a client, the data request directed to data stored in a plurality (N) of data shards and splits the original request to N data shards into smaller chunks. For example, each chunk of request may include request to N/F data shards, where the chunking factor F is determined based on a number of parameters related to the query system, such as the size of the data shards, the latency of request fulfilment from the data shards, the availability of the bandwidth for the data shards, etc.

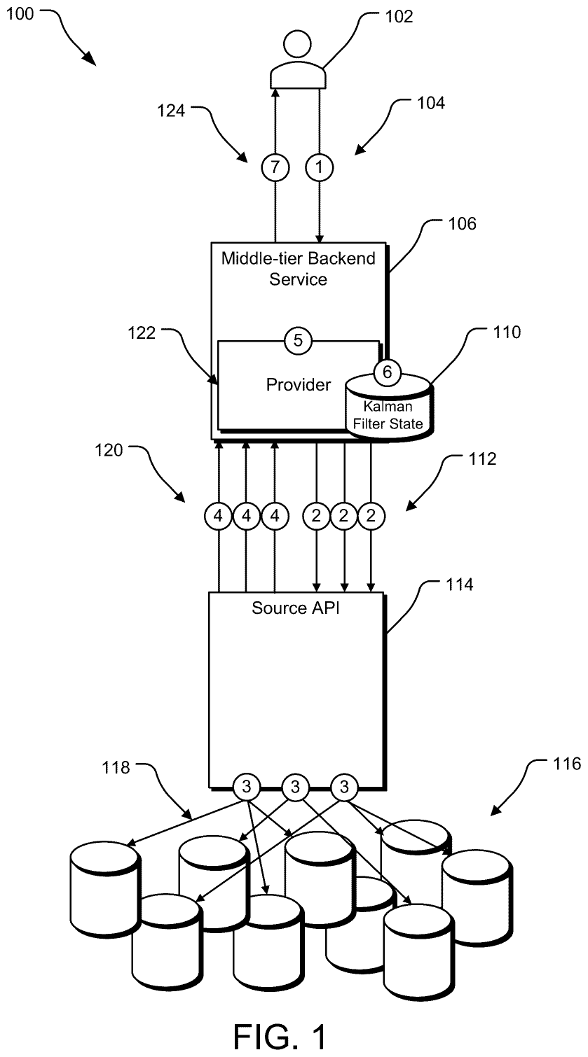

FIG. 1 illustrates an implementation of a high latency query optimization system 100 disclosed herein. The system 100 includes a middle-tier back end service 106 communicatively connected to a client 102. The middle-tier back end service 106 may also be connected to a source API 114 that is in communication with a number of data shards 116. For example, the data shards 116 may be configured to host horizontal data of a database on a number of different data servers.

At 104, a client-side experience/user at the client 102 requests for data from the backend service 106. For example, the data may contain results collected from N of the plurality of data shards 116. The middle-tier backend service 106 accepts the client request and divides the client request to N data shards 116 into N/F data shard requests where F is a chunking factor that is determined based on a number of data shard parameters. Thus, each of the N/F requests is directed a subset of the N data shards 116. At 112, the middle-tier backend service 106 communicates the N/F data shard requests to a source API 114. In one implementation, the N/F data shard requests are communicated to the source API 114 in parallel.

The source API 114 accepts the N/F data shard requests from the middle-tier backend service 106. Subsequently at 118, the source API 114 fans out the N/F data shard requests to the individual of the N data shards 116. At 118, the data shards N returns data in return to the N/F data shard requests to the middle-tier backend service 106. As some of the data shards 116 may have a higher latency than the others, some of the N/F data shard requests may be returned earlier than the others. At 120, the source API 114 communicates the responses to the N/F data shard requests to the middle-tier backend service 106. In one implementation, the source API 114 communicates the responses to the N/F data shard requests to the middle-tier backend service 106 in parallel. However, in one implementation the responses to the N/F data shard requests are sent at different times as they are received from the data shards 116.

At 122, the middle-tier backend service 106 performs a best effort attempt at collecting the responses to the N/F data shard requests returned to it from the Source API 114. The middle-tier backend service 106 may also monitor the latency parameter related the responses to the data shard requests. For example, the middle-tier backend service 106 may measure and tabulate the time taken to receive the responses. Alternatively, the middle-tier backend service 106 may also preemptively perform ping tests to each of the data shards and tabulate the results of such ping test as the latency parameter related to the data shards. In yet another implementation, the middle-tier backend service 106 may request the data shards to provide the breakdown of the latency, such as network latency, disk latency, etc.

For example, some data shards may have higher network latency due to traffic on the networks connecting to the data shards, whereas some other data shards may have higher disk latency due to health of the disk where the data is stored, the number of requests to the disks, etc. Here the network latency describes a delay that takes place during communication over a network to the data shard whereas the disk latency may refer to the delay between the time data is requested from a storage device where the data shard is configured and when the data starts being returned. In yet another implementation, the data shards may also notify the middle-tier backend service 106 of other latency parameters related to the data shards, such as RAM latency for the local storage controllers, CPU latency of the local storage controllers, etc.

Based on the latency parameters of the various data shards 116, some of the responses to the N/F data shard requests may have arrived, whereas others may take longer to return. The middle-tier backend service 106 may stop waiting for responses beyond a predetermined cutoff and return partial results to the client 102. In one implementation, such predetermined cutoff may be determined based on the type of client, the type of client request, the identity of the data shards that are missing the response, the values of the various latency parameters related to the data shards, etc.

In one implementation, the middle-tier backend service 106 is further enhanced by utilizing a stateful Kalman filter 110, which allows the middle-tier backend service 106 to self-select the best parameters at any given time, without requiring human intervention. A Kalman filter measures a series of measurements observed over time and produces estimates of unknown variables that tend to be more accurate than those based on a single measurement alone. Thus, for example, the stateful Kalman filter 110 may observe the latency parameters for the data shards over time and generate output estimates of the states of latency for the various data shards.

Furthermore, the Kalman filter uses a persistent state to balance the ratio between the chunking factor F, the observed latencies of each chunk returned from the source API 114, and the overall load on the high latency query optimization system 100. Specifically, the persistent state of the system 100 may be a state that continues to exist even when there are no data access processes are present. Thus, the Kalman filter may use a persistent state in the absence of queries to balance the ratio between the chunking factor F, the observed latencies of each chunk returned from the source API 114, and the overall load on the high latency query optimization system 100. Subsequently, at 124, the middle-tier backend service 106 accepts the result from the source API 114, and prepares a response which is returned back to the client-side experience 102.

The query optimization system 100 provides advantages over other query system in that the latency of the middle-tier backend service 106 is guaranteed to be at-most latency cutoff timeout, or less (if all chunks were returned from the Source API in due time). Compared to that in prior implementations of query systems, the latency of a middle-tier backend service is dictated by how long a call to the source API takes to complete and is outside of the control of the middle-tier backend service.

Furthermore, the query optimization system 100 provides advantages over other query system in that it can be configured to give a best-effort result by spreading the calls to source APIs over N/F chunks, thus increasing the chance of partial data to return. Subsequently, the data is collected from the chunks that succeeded, thus allowing for partial data to be returned to the client. The best effort implementation of the query optimization system 100 also allows the system to cancel outbound calls that haven't completed in-time, thus further reducing strain on the query optimization system 100. Additionally, with the query optimization system 100 latency parameters such as latency cutoff time, chunking factor F, etc., can be exposed and are customizable.

In alternative implementation, the query optimization system 100 may also control the data retrieval latencies using system operating parameters such as chunk size, fanout factor, and total timeout. Furthermore, the query optimization system 100 may use a fanout algorithm to scenarios where an original request from the client 102 is broken down into smaller chunks and expose parameters such as chunk size and fanout factor. Additionally, the query optimization system 100 may also impose a total duration on each or some of the parallel fanout requests and then expose such total duration requests as parameters. In such implementations, each fanout request may also be allowed to return partial results and then free up its resources one a time-out is reached.

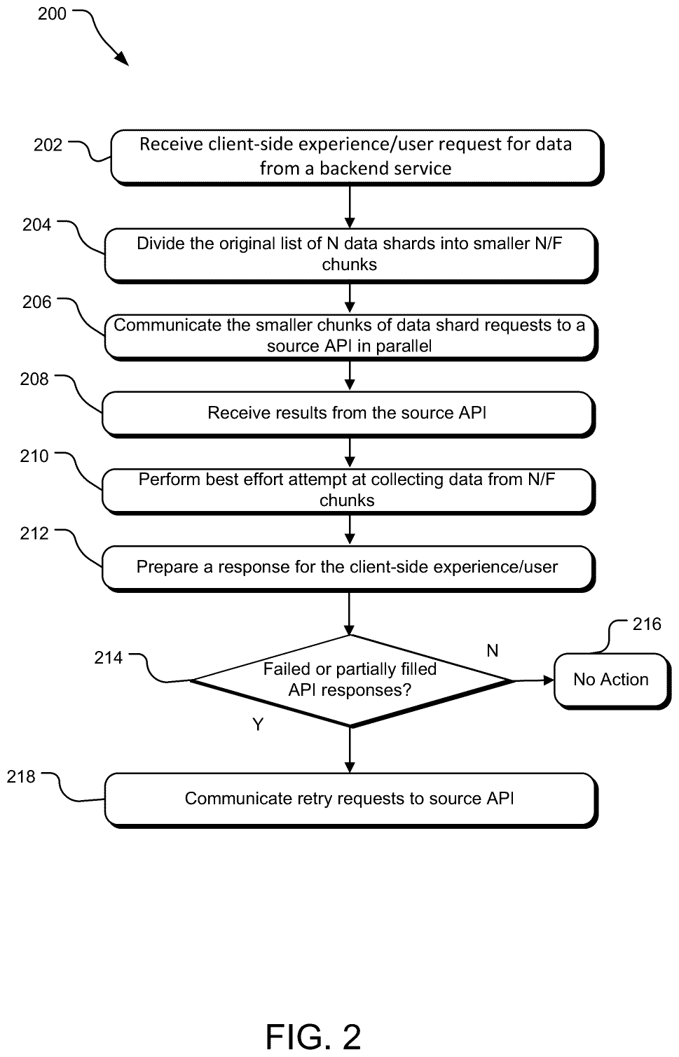

FIG. 2 illustrates operations 200 of the high latency query optimization system disclosed herein. An operation receives client-side experience/user requests for data from a backend service. The requested data may contain results collected from N data shards. An operation 204 accepts the user's request at a middle-tier backend service and divides the original list of N data shards into smaller chunks. In one implementation, the original list of N data shards may be divided by a chunking factor F so that each data shard request includes N/F data shards. An operation 206 communicates the F data shard requests, each requesting data from N/F data shards in parallel to a source API. Thus, for example, if the initial request was to request data from N=30 data shards and the chunking factor F is 5, each of the 5 requests is for data from 6 data shards.

The source API accepts request for N/F data chunks from the middle-tier backend service. Each chunk may be handled by the source API by fanning out data requests to the individual data shards. The source API receives the data from the data shards and each chunk is returned to the middle-tier backend service separately from the other chunks. An operation 208 receives results of the data requests from the source API at the middle-tier backend service. An operation 210 performs a best effort attempt at collecting data from the N/F chunks returned to it from the source API. As each data chunk request is receiving data from different data shards, data from some data chunk request may be received earlier than the data from other of the data chunk requests. In one implementation, the middle-tier backend service determines at what point it will group the data to fulfill the request from the user. Subsequently, an operation 212 prepares a response for the client-side experience/user based on the determination of when to group the data.

Subsequently an operation 214 determines if there are any source API requests that had a failed response or a response that is only partially filled. For example, operation 214 determines if requests to a one or more data shards did not return data in time or the response provided incomplete results. If so, an operation 218 communicates a retry request to the source API to collect data for the failed or partially filled data. If all data is collected as per operation 216 no action is required.

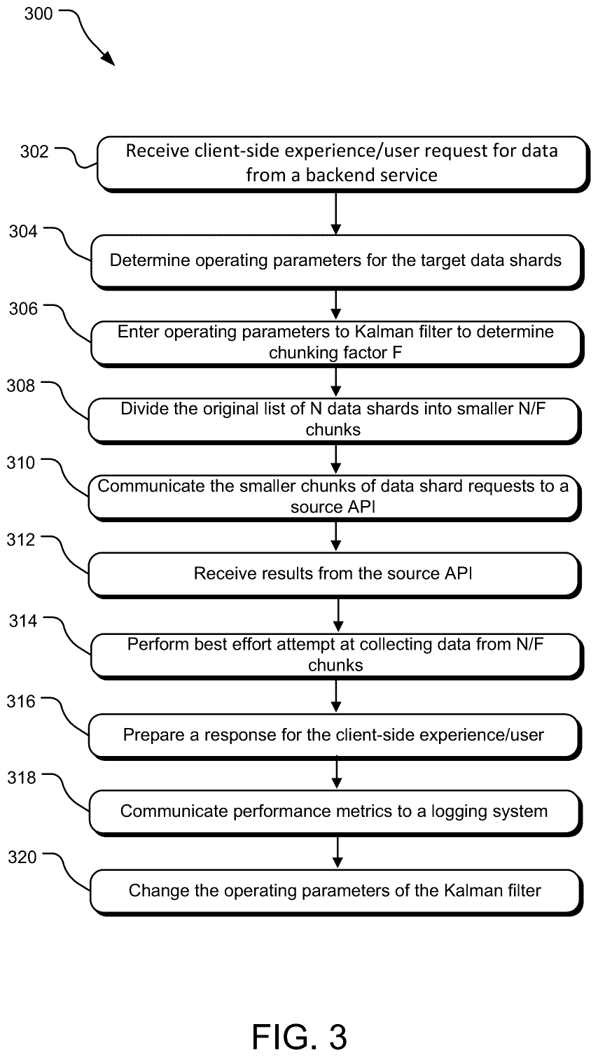

FIG. 3 illustrates alternative operations 300 of the high latency query optimization system disclosed herein. Specifically, the operations 300 illustrate an implementation wherein a stateful Kalman filter is used to self-select the parameters that are used to determine chunking of the requests to the N data shards. Thus, an operation 304 determines one or more operating parameters for the N target data shards. For example, the operation 304 may determine the latency of one or more of the N data shards, the availability of the bandwidth to one or more of the N data shards, the size of the N data shards, the selection of the API used to communicate with the N data shards, etc. The Kalman filter allows the middle-tier backend service to self-select the optimal parameters at any given time without requiring human intervention. In one implementation, a persistent state is used to balance the ratio between the chunking factor F and the observed latencies of each chunk returned from the source API.

An operation 306 uses a Kalman filter to determine the chunking factor F. Specifically, one or more of the operating parameters of the N data shards are input to a stateful Kalman filter, which generates as output the value of the chunking factor. An operation 308 divides the original list of N data shards into smaller N/F chunks of data shard requests. Subsequently, an operation 310 communicates the smaller chunks of data shard requests to a source API. Once the source API has processed the requests, an operation 312 receives the results of the results of the queries from the source API. An operation 314 performs a best effort attempt at collecting data from the N/F chunk. For example, such best effort attempt may be based on a time-out parameter or a total time-duration parameter set by the system.

An operation 316 prepares a response for the client side experience based on the response from the source API. In one implementation, an operation 318 communicates performance metrics to a logging system. Specifically, the performance metrics may be used for learning and investigation purposes. An operation 320 uses the performance metric to fine-tune the operating parameters and the algorithms used internally within the Kalman filter.

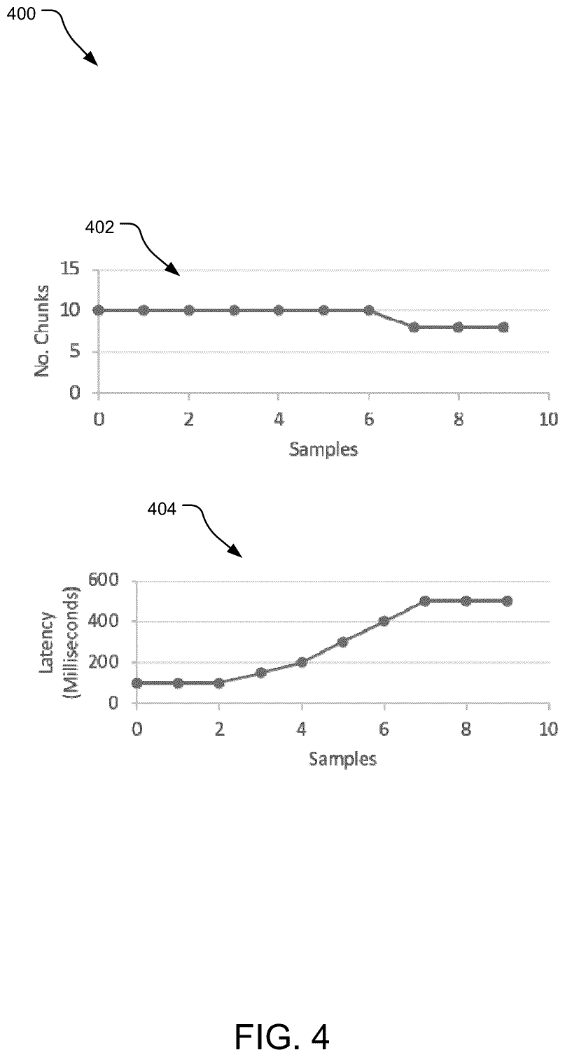

FIG. 4 illustrates graphs 400 of relationships between number of samples to various parameters of the query that may be used by a Kalman filter of the high latency query optimization system disclosed herein. As shown in the graph 402, initially the number of data shard per chunk is set to 10. As the data is returned from the data shards, the latency of the receiving the data is observed. As illustrated in graph 404, the latency may start increasing. As the latency increases, the number of data shards per chunk may be reduced to 8. As a result, as shown in graph 402, the latency may start stabilizing and therefore, the number of data shards per chunk is kept at 8.

While the above example uses the latency for determining the chunking factor, other parameters such as CPU usage, the number of contentions, the usage of RAM, the number of threads, throttling statistics, etc., may be used to determine the number of chunks and/or the size of the chunks. In some implementation, the Kalman filter may increase or decrease the number of chunks based on the observed values of the parameters. Alternatively, the Kalman filter may increase or decrease the size of chunks based on the observed values of the parameters.

The high latency query optimization system disclosed herein provides a number or advantages over the other implementations that do not use the technology disclosed herein. For example, using the high latency query optimization system disclosed herein, the latency of the middle-tier backend service may be guaranteed to be a predetermined latency cutoff timeout, or less if all chunks were returned from the Source API in due time. Furthermore, using the best-effort implementation of the high latency query optimization system disclosed herein the number of calls is spread over N/F chunks, thus increasing the chance of partial data to return. Subsequently, data is collected from the chunks that succeeded, which allows for partial data to be returned to the client. Additionally, in the illustrated implementations, the parameters such as latency cutoff timeout and chunking factor F are exposed and are customizable. This allows the parameters to be continuously fine-tuned and optimized based on the systems behavior in real-time, using for example, a Kalman filter. Furthermore, the best effort implementation also allows the high latency query optimization system to cancel outbound calls to source API that haven't completed in-time, further reducing strain on the system.

In an alternative implementation, the high latency query optimization system uses various key factors, such as query-time latency, data-freshness, completeness/coverage to determine chunking factor. Here the query-time latency indicates how long it takes for the client to get the data back from the server at query time, data freshness indicates how up to date is the data the server returns, relative to the moment of query, and the completeness/coverage indicates how much data will the server return.

In some implementation, a combination of these factors may be used to determine the chunking factor. For example, when the combination of the query-time latency and data-freshness is used the system fetches data in real-time from the source itself to optimize the data freshness or it fetches as little data as possible to optimize for query time latency, thus sacrificing the completeness/coverage. Alternatively, if the combination of data-freshness and completeness/coverage is used to determine the chunking factor, they system fetches data in real-time from the source itself to optimize the data freshness or it fetches as much data as possible to optimize the completeness/coverage, thus sacrificing the query-time latency. On the other hand, if the system uses query-time latency and completeness/coverage to determine chunking factor, the system prepares the data asynchronously and makes it easily available through a fast store, thus sacrificing the data-freshness.

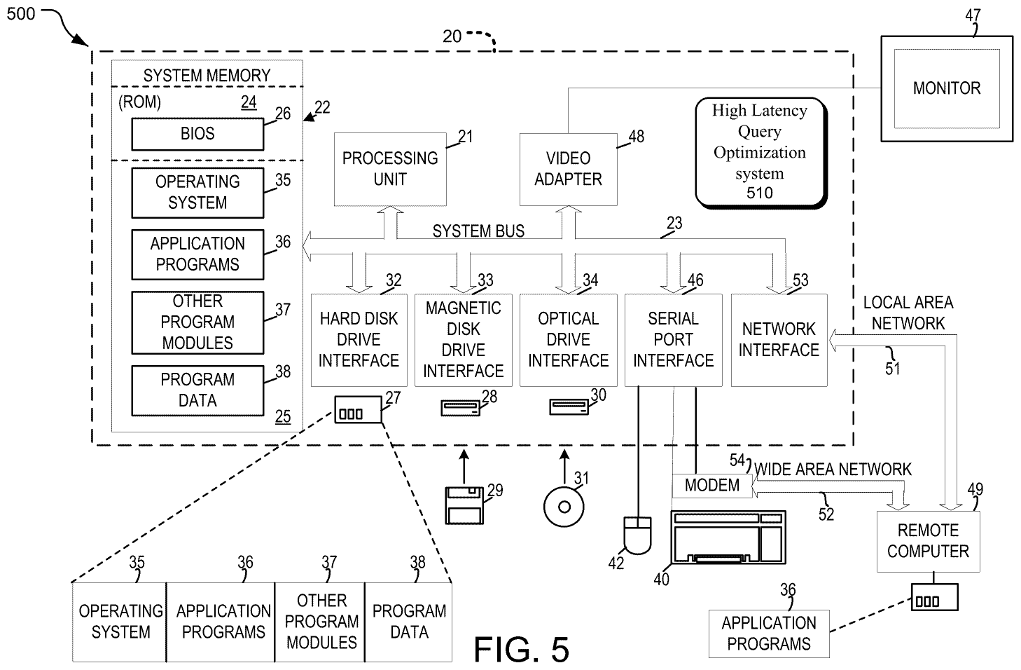

FIG. 5 illustrates an example system 500 that may be useful in implementing the high latency query optimization system disclosed herein. The example hardware and operating environment of FIG. 5 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 5, for example, the computer 20 includes a processing unit 21, a system memory 22, and a system bus 23 that operatively couples various system components, including the system memory 22 to the processing unit 21. There may be only one or there may be more than one processing units 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures, including a memory bus or memory controller, a peripheral bus, a switched fabric, point-to-point connections, and a local bus using any of a variety of bus architectures. The system memory 22 may also be referred to as simply the memory and includes read-only memory (ROM) 24 and random-access memory (RAM) 25. A basic input/output system (BIOS) 26, contains the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement a high latency query optimization system disclosed herein. In one implementation, a frequency unwrapping module, including instructions to unwrap frequencies based at least in part on the sampled reflected modulations signals, may be stored in memory of the computer 20, such as the read-only memory (ROM) 24 and random-access memory (RAM) 25.

Furthermore, instructions stored on the memory of the computer 20 may be used to generate a transformation matrix using one or more operations disclosed in FIG. 5. Similarly, instructions stored on the memory of the computer 20 may also be used to implement one or more operations of FIG. 4. The memory of the computer 20 may also one or more instructions to implement the high latency query optimization system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device, or other common network node, and typically includes many or all of the elements described above relative to the computer 20. The logical connections depicted in FIG. 5 include a local-area network (LAN) 51 and a wide-area network (WAN) 52. Such networking environments are commonplace in office networks, enterprise-wide computer networks, intranets, and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software, or firmware instructions for the high latency query optimization system 510 may be stored in system memory 22 and/or storage devices 29 or 31 and processed by the processing unit 21. high latency query optimization system operations and data may be stored in system memory 22 and/or storage devices 29 or 31 as persistent data-stores.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments of high latency query optimization system may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain function. The instructions may be implemented using any suitable high-level, low-level, object-oriented, visual, compiled and/or interpreted programming language.

The high latency query optimization system disclosed herein may include a variety of tangible computer-readable storage media and intangible computer-readable communication signals. Tangible computer-readable storage can be embodied by any available media that can be accessed by the high latency query optimization system disclosed herein and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the high latency query optimization system disclosed herein. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals moving through wired media such as a wired network or direct-wired connection, and signals moving through wireless media such as acoustic, RF, infrared and other wireless media.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

A method described herein includes receiving a data request from a client, the data request directed to data stored in a plurality of data shards, determining a set of operating parameters of the data shards for retrieving data from the plurality of shards, determining a chunking factor based on the set of operating parameters, dividing the data request into a plurality of API requests based on the chunking factor, each of the API requests directed to a portion of the plurality of data shards, and communicating the plurality of API requests in parallel to a source API configured to perform data queries on the plurality of data shards.

Another implementation discloses one or more physically manufactured computer-readable storage media, encoding computer-executable instructions for executing on a computer system a computer process, the computer process including receiving a data request from a client, the data request directed to data stored in a plurality of data shards, determining a set of latency parameters of the data shards for retrieving data from the plurality of shards, determining a chunking factor based on the set of latency parameters, dividing the data request into a plurality of API requests based on the chunking factor, each of the API requests directed to a portion of the plurality of data shards, and communicating the plurality of API requests in parallel to a source API configured to perform data queries on the plurality of data shards.

A system disclosed herein includes a memory, one or more processing units, and a query optimization system stored in the memory and executable by the one or more processor units, the query optimization system encoding computer-executable instructions on the memory for executing on the one or more processor units a computer process, the computer process includes receiving a data request from a client, the data request directed to data stored in a plurality of data shards, determining a set of latency parameters of the data shards for retrieving data from the plurality of shards, determining a chunking factor based on the set of latency parameters, dividing the data request into a plurality of API requests based on the chunking factor, each of the API requests directed to a portion of the plurality of data shards, and communicating the plurality of API requests in parallel to a source API configured to perform data queries on the plurality of data shards.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. A method comprising:
receiving a data request from a client, the data request directed to data stored in a plurality of data shards;
determining a set of operating parameters of the data shards for retrieving data from the plurality of shards;
determining a chunking factor based on the set of operating parameters;
dividing the data request into a plurality of API requests based on the chunking factor, each of the API requests directed to a portion of the plurality of data shards; and
communicating the plurality of API requests in parallel to a source API configured to perform data queries on the plurality of data shards.

2. The method of claim 1, wherein the set of operating parameters further comprises latency parameters for one or more of the data shards.

3. The method of claim 2, wherein determining the chunking factor based on the set of operating parameters further comprising using a stateful Kalman filter to determine the chunking factor based on the set of operating parameters.

4. The method of claim 1, wherein the set of operating parameters comprises query-time latency parameters for one or more of the data shards and data-freshness of the data received from the one or more of the data shards.

5. The method of claim 1, wherein the set of operating parameters comprises query-time latency parameters for one or more of the data shards and completeness of the data received from the one or more of the data shards.

6. The method of claim 1, wherein the set of operating parameters comprises data-freshness of the data received from the one or more of the data shards and completeness of the data received from the one or more of the data shards.

7. The method of claim 1, further comprising:
receiving data in response to the plurality of API requests;
grouping the received data received based on a predetermined latency cutoff timeout; and
communicating the grouped data to the client.

8. The method of claim 1, further comprising, in response to determining that one or more of the API requests has failed or has been partially filled resulting in missing data, communicating one or more additional API requests to the source API configured to perform data queries on the plurality of data shards for the missing data.

9. The method of claim 1, Further comprising communicating performance metrics to a logging system wherein the performance metrics may be used for further inspection, analysis and investigation of the operating parameters used for determining the chunking factor.

10. The method of claim 9, further comprising changing a set of operating parameters and an algorithm used by a stateful Kalman filter to determine the chunking factor based on the set of operating parameters.

11. One or more physically manufactured computer-readable storage media, encoding computer-executable instructions for executing on a computer system a computer process, the computer process comprising:
receiving a data request from a client, the data request directed to data stored in a plurality of data shards;
determining a set of latency parameters of the data shards for retrieving data from the plurality of shards;
determining a chunking factor based on the set of latency parameters;
dividing the data request into a plurality of API requests based on the chunking factor, each of the API requests directed to a portion of the plurality of data shards; and
communicating the plurality of API requests in parallel to a source API configured to perform data queries on the plurality of data shards.

12. The one or more physically manufactured computer-readable storage media of manufacture of claim 11, wherein determining the chunking factor based on the set of latency parameters further comprising using a stateful Kalman filter to determine the chunking factor based on the set of operating parameters.

13. The one or more physically manufactured computer-readable storage media of claim 11, wherein the set of latency parameters comprises query-time latency parameters for one or more of the data shards and data-freshness of the data received from the one or more of the data shards.

14. The one or more physically manufactured computer-readable storage media of claim 11, wherein the computer process further comprising:
receiving data in response to the plurality of API requests;
grouping the received data received based on a predetermined latency cutoff timeout; and
communicating the grouped data to the client.

15. The one or more physically manufactured computer-readable storage media of claim 11, wherein the computer process further comprising in response to determining that one or more of the API requests has failed or has been partially filled resulting in missing data, communicating one or more additional API requests to the source API configured to perform data queries on the plurality of data shards for the missing data.

16. A system comprising:
memory;
one or more processor units; and
a query optimization system stored in the memory and executable by the one or more processor units, the query optimization system encoding computer-executable instructions on the memory for executing on the one or more processor units a computer process, the computer process comprising:
receiving a data request from a client, the data request directed to data stored in a plurality of data shards;
determining a set of latency parameters of the data shards for retrieving data from the plurality of shards;
determining a chunking factor based on the set of latency parameters;
dividing the data request into a plurality of API requests based on the chunking factor, each of the API requests directed to a portion of the plurality of data shards; and
communicating the plurality of API requests in parallel to a source API configured to perform data queries on the plurality of data shards.

17. The system of claim 16, wherein determining the chunking factor based on the set of latency parameters further comprising using a stateful Kalman filter to determine the chunking factor based on the set of operating parameters.

18. The system of claim 16, wherein the set of latency parameters comprises query-time latency parameters for one or more of the data shards and data-freshness of the data received from the one or more of the data shards.

19. The system of claim 16, wherein the computer process further comprising:
receiving data in response to the plurality of API requests;
grouping the received data received based on a predetermined latency cutoff timeout; and
communicating the grouped data to the client.

20. The system of claim 16, wherein the computer process further comprising in response to determining that one or more of the API requests has failed or has been partially filled resulting in missing data, communicating one or more additional API requests to the source API configured to perform data queries on the plurality of data shards for the missing data.
